(19) United States
(12) Patent Application Publication
(10) Pub. No.: US 2019/0101157 A1
(43) Pub. Date: Apr. 4, 2019

(54) Renovated Shaft Bearing and Method of Manufacture

(71) Applicant: Robert Alan Shortridge, SR., Powhatan, VA (US)

(72) Inventor: Robert Alan Shortridge, SR., Powhatan, VA (US)

(21) Appl. No.: 16/139,867

(22) Filed: Sep. 24, 2018

Related U.S. Application Data
(60) Provisional application No. 62/567,411, filed on Oct. 3, 2017.

(51) Int. Cl. F16C 33/18; F16C 35/02; F16C 43/02

(52) U.S. Cl. CPC F16C 33/18; F16C 35/02; F16C 43/02; F16C 2237/00; F16C 2226/76; F16C 2226/60; F16C 2212/04

(57) ABSTRACT

The renovated bearing and the method of constructing the renovated bearing includes a trimmed off foundation base with a new wear block secured to the foundation base and adapted to bear against a rotating shaft to keep it from vibrating or otherwise rotating out of true. By reusing, or rather continuing using, a foundation base portion of an existing bearing, only the duty wearing block component can be replaced simply and economically. This reduces wastage of the larger bearing composition mass. A like-new bearing can be assembled quickly and more economically than a complete replacement of a bearing.

This application claims the benefit of U.S. Provisional Patent Application No. 62/567,411 filed Oct. 3, 2017, which is incorporated by reference herein in its entirety.

The present invention relates to shaft bearings formed from large blocks of material. The renovated bearing described herein has only the wear face of the bearing replaced instead of replacing the entire, larger bearing block of material. Replacing the wear face may be especially useful when the composition of the entire bearing or at least the wear portion of the bearing is lignum vitae wood.

### BACKGROUND

Industrial and utility rotating shafts are used for many purposes. These rotating shafts are secured in one or more bearings to act as a sacrificial wear component, keep the shaft spinning in a true orbit, and prevent or reduce the vibration that may otherwise occur during rotation which, in extreme cases, may lead to shaft overheating and system failure. FIG. 1 is a top view of a rotating shaft 12 secured between four bearings 10. As shown in FIG. 2, each bearing 10 has a wear face 14 that engages the surface of a rotating shaft. In one example, a number of older hydroelectric plants have deployed for many years lignum vitae wood bearings. Often, these lignum vitae bearings are formed from very large blocks of lignum vitae wood that was relatively more widely available at the time of their original installation. These large blocks of solid lignum vitae wood include pieces that may be 5 to 30 inches in length and width of a bearing wear face and have a depth of 3 to 24 inches.

Unfortunately, lignum vitae wood is a natural resource that is not widely available like it historically once was. Accordingly, lignum vitae wood has become relatively expensive. This means that the cost to replace old, existing lignum vitae bearings can be prohibitively expensive in some applications. For example, small hydroelectric plants may not be able to reasonably replace the large blocks of lignum vitae bearing blocks that have served them for many years. Alternative compositions that are less durable may be the only cost-effective solutions.

Similarly, large blocks of other metals, composites and polymer materials may be used in a bearing construction. Sometimes these bearing blocks are formed of very expensive or rare materials. Replacement of the entire bearing is wasteful and presents engineering challenges when fabricating a replacement bearing.

### SUMMARY

Accordingly, it is an object of the present invention to overcome the drawbacks of existing methods and strategies for replacing worn shaft bearings. By trimming off a portion of the worn bearing and securing a replacement wear block to the remaining foundation of the old bearing, a new bearing is created that only requires a fraction of new material as compared with a complete replacement bearing.

In one example, a renovated shaft bearing comprises a foundation base and a replacement wear block. The foundation base is adapted to fit securely in a bearing housing, and the foundation base includes a contact side that is adapted to be oriented to face a rotating shaft. The replacement wear block has a back side and on its opposite side to the back side a wear face, and the back side is fixed to the contact side of the foundation base and the wear face is shaped to engage an outside diameter of the rotating shaft. The contact side of the foundation base and the back side of the replacement wear block may be each substantially flat, or they may each have a curved surface that is reciprocal to each other and that nest together. The contact side of the foundation base and the back side of the replacement wear block may each have a zig-zag surface that is reciprocal to each other and that nest together. Still further alternatively, the respective flat faces, in the example of two flat faces, each have reciprocal grooves therein, and the bearing further comprises wedges that are inserted into and hold the foundation base and replacement wear block together. The wedges may be dovetail wedges that hold the foundation base and replacement wear block together, or they may be I-beams that hold the foundation base and replacement wear block together. In another alternative, the wear face has a hole therein, and the hole has a wide diameter section and a narrow diameter section. The wide diameter section extends across the wear face and part way through the cross section of the wear block to a bottom of the wide diameter section, and the narrow diameter section extends from the bottom of the wide diameter section and out through the back side of the replacement wear block. The bearing further comprises a fastener with a head and a body, wherein the head seats on the bottom of the wide diameter section of the hole and the body extends through the narrow section of the hole and is secured in the foundation base and secures the replacement wear block to the foundation base. In still further alternatives, the foundation base and the replacement wear block are formed of different materials. They may be formed of lignum vitae wood. The replacement wear block may have a cross-sectional depth, as measured from the center of the width of the bearing, of from about one half to six inches.

In another example, a method of making a renovated shaft bearing comprises several steps including removing a shaft bearing from a bearing housing, wherein the shaft bearing has a contact face that engages a rotating shaft. The steps also include cutting off the face of the shaft bearing to form a foundation base of the remaining portion of the shaft bearing, and the foundation base includes a contact side that is adapted to be facing the rotating shaft. The next step is providing a replacement wear block that has a back side and a wear side, and wherein the back side of the replacement wear block has a surface that is adapted to be secured to the contact side of the foundation base, and then securing the back side of the replacement wear block to the contact side of the foundation base. A further step is milling a radius of the rotating shaft into the wear side of the replacement wear block, whereby the combination of the wear block face and the foundation base form a new shaft bearing.

### BRIEF DESCRIPTION OF THE DRAWINGS

FIG. 1 is a top, cross-sectional view of a rotating shaft set inside four solid wood bearings.

FIG. 2 is a top view of a single bearing block formed from a solid block of wood.

FIG. 3 is a perspective view of a single bearing block illustrating width, length and depth dimensions of the bearing.

FIG. 4 is a perspective view of a single bearing block illustrating different grain orientations for a wood bearing.

FIG. 5 is a top, cross-sectional view of a bearing having a new wear block attached to the foundation base of an old bearing using dovetail wedges.

FIG. 6 is a top, cross-sectional view of a bearing having a new wear block attached to the foundation base of an old bearing using fasteners.

FIGS. 7-12 are top, cross-sectional views of bearings with new wear blocks attached to foundation bases where the contact faces of the respective block and base have alternative cross-sectional geometries.

FIG. 13 is a top, cross-sectional view of a bearing where the wear block and foundation base are shown as being formed of different materials.

FIGS. 14 A-D are a series of drawings that illustrate one example of a process of renovating an old bearing and attaching a new wear block onto it.

FIG. 15 is a perspective view of a rotating shaft in a bearing housing with the four bearings removed from the bearing housing.

FIG. 16 is a perspective view of a bearing.

FIG. 17 is a top view of the bearing shown in FIG. 16 with a line drawn across it indicating where the wear face block will be cut off of the foundation base portion of the bearing.

FIG. 18 is a top view of a foundation base of a bearing with a flat face where the wear block portion has been trimmed off and then attachment grooves have been milled into the face and foundation base.

FIG. 19 is a top view of a new wear block with a flat back side and grooves milled in the face and block and several I-beam shaped wedges used to join the wear block and the foundation base together.

FIG. 20 is a top view of a bearing with a new wear block secured to a foundation base using I-beam shaped wedges.

FIG. 21 is a top view of the renovated bearing with the new wear block on the old foundation base with the curve of the shaft milled into the wear face of the wear block.

### DETAILED DESCRIPTION

The renovated bearing and the method of constructing the renovated bearing includes a trimmed off foundation base with a new wear block secured to the foundation base and adapted to bear against a rotating shaft to keep it spinning in a true orbit and dampen vibration. By reusing, or rather continuing using, a foundation base portion of an existing bearing, only the duty wear block component can be replaced simply and economically. This reduces wastage of the larger bearing composition mass. A like-new bearing can be assembled quickly and more economically than a complete replacement of a bearing.

The renovated bearing has two essential components, a foundation base and a replacement wear block that are secured to each other. Each component and the alternative methods of fixing or securing them to each other will be discussed in detail in the following examples.

A foundation base is a substantial portion of a bearing that requires renovation. In use over time, an existing bearing will be subject to wear and contamination that causes the bearing to be unable to function properly as a way of securing a rotating shaft without vibration. Rather than replacing the entire bearing, only a portion of that worn bearing including the wear face and a proximate portion of the bearing is trimmed off. This trimming results in the formation of the foundation base for a renovated bearing. Referring to FIG. 3, the dimensions of a bearing 10 are identified as the width w, length l, and the depth d. It is a portion of the depth d of a worn bearing that is trimmed to form a foundation base. The amount of the worn bearing that is trimmed may be determined based on the duty requirements of the bearing. The trim allows the substitution of new wear material as the bearing face. For example, one typical bearing may wear 15-20 mil per year, so providing another ½″ of thickness can offer an additional 20-25 years of service.

In one example, about one-half to 6 inches may be trimmed off of a worn bearing, or alternatively about 1 to 4 inches. The amount trimmed is measured from the center of the width w of the bearing and then in the direction of the depth d of the bearing. The amount of worn bearing may also vary depending on the geometry of the contact face between the foundation base and a replacement wear block.

The replacement wear block has the shape and general dimension of that portion of the original worn bearing that is trimmed off. Because the worn bearing face is by definition worn, the replacement wear block will have a depth that is at least a little bit bigger than the depth of the trimmed portion. The width and length of the replacement wear block will be about the same as the foundation base and the original, worn bearing. For instance the depth of the replacement wear block may be about one-half to 6 inches, or alternatively, about 1 to 4 inches. This measurement is taken from the middle of the width w of the wear block and in the direction of the depth d of the wear block. Qualitatively speaking, the replacement wear block is usually thinner in lower stress bearing requirement situations and relatively thicker in a heavy stress bearing requirement.

The material that makes up the foundation base and the wear block may be the same or different. In many and perhaps most cases, the wear block that is secured to the foundation base will be the same material. For instance, an old and worn lignum vitae bearing may be trimmed and a replacement lignum vitae wear block secured to the lignum vitae foundation block. Other woods may be used depending on the bearing performance requirements. Also, a more modern polymer bearing that is worn may be trimmed and an alternative polymer or a wood, in one example lignum vitae, wear block may be attached to that polymer foundation block. Or still further alternatively, a worn wooden bearing may be trimmed, and a polymer wear block may be secured to the wood foundation base.

The lignum vitae wood described herein is from the Guaiacum genus of trees. This includes Guaiacum Officinale, Guaiacum sanctum, and Guaiacum Coulteri species. Lignum vitae wood is believed to be the densest wood that is reasonably available in that it will easily sink in water and has a Janka scale hardness of about 4,500, similar to aluminum. An additional benefit of using lignum vitae wood blocks is the inherent presence of the guaiacum resin that exists in the natural lignum vitae wood. The presence of the guaiacum resin results in the ever-present existence of lubrication allowing a mixed mode of lubrication of the wood blocks. There is a water lubrication of the wood bearing faces, however there is also the presence of the guaiacum resin as a lubricant on the face of the wood blocks. As a result, there are the mixed modes of water and resin lubrication of the wood block surfaces.

When the wear block is fruited from lignum vitae wood or any other type of wood, the grain of the wood may be considered. Naturally, a wood grain is necessarily a general statement, because the wood grain varies in some amount as a result of its natural formation. Wood grain is therefore considered to be the predominant direction of the grain of the wood use. Referring to FIG. 4, the grain of the wood bearing 10 may be end grain g1 with is generally perpendicular to the wear face of the wear block in the middle of the depth of the wear block. One subset of an end grain orientation is a center cut or heart cut where the end grain includes the center of the wood tree or branch that forms the wear block. The grain may be long grain g2 in that it is substantially horizontal to the rotation of a shaft adjacent the bearing wear face. The grain may be cross grain g3 which is vertical to the horizontal rotation of a shaft on the bearing face. The wear block may be cut to have any of these wood grains including varying degrees in between pure end, long and cross grain. Both end grain and long grain are believed to be especially favorable for use in forming a wear block. When multiple bearings around a specific shaft installation are being renovated with a new wear block, the orientation of the wood grain may be strategically selected to be the same or different depending on the observed wear patterns of the worn bearings that are being renovated.

It is important that the wear block and foundation block are strongly secured to each other. It is at least hypothetically possible that a strong adhesive is all that is required. However, it is believed that some mechanical fastener of contact face geometry is favored or required to secure the two components together.

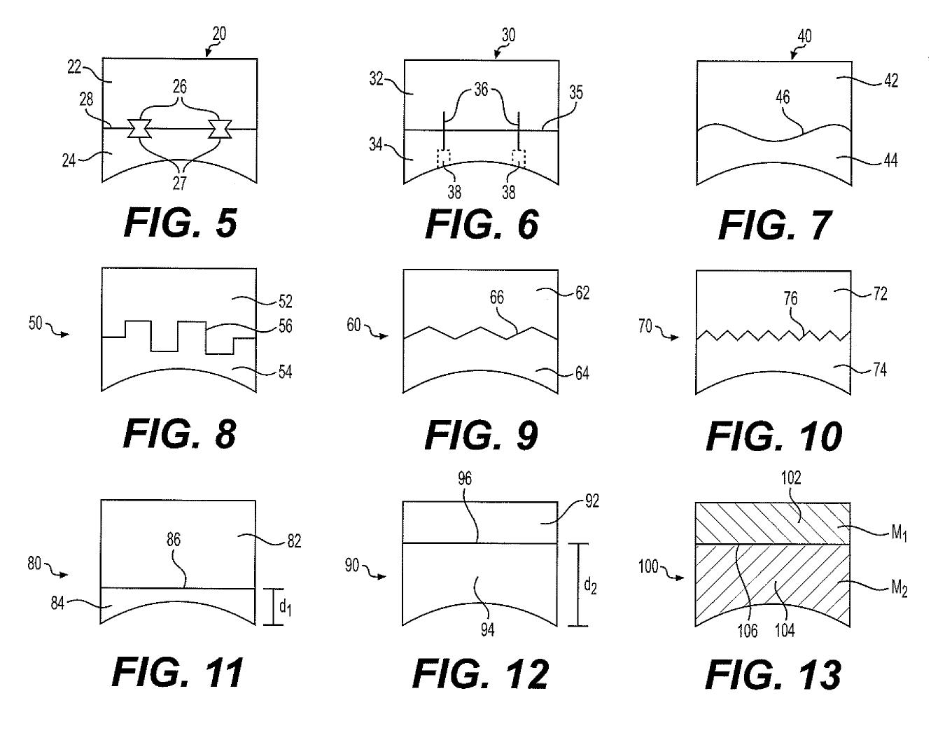

In FIGS. 5 and 6, the foundation block was trimmed with a straight cut across the width of the worn bearing. FIG. 5 shows a bearing 20 having a foundation block 22 and a wear block 24 that are secured to each other along a straight and flat contact surface 28. Similarly, in FIG. 6, a bearing 30 has a foundation block 32 and wear block 34 that are secured to each other along a flat and straight contact surface 35. In FIG. 5 dovetail or tee shaped grooves 27 are machined out or milled out of the respective contact faces on the foundation block 22 and wear block 24. The grooves 27 are positioned to be reciprocal across from each other. A dovetail or I-beam shaped wedge 26 is then hammered into place to lock the wear block 24 onto the foundation base 22. The wedge 26 is intentionally relatively low in profile so that the depth thickness of the wear block 24 is maximized. In FIG. 5, there are shown two offset dovetail wedges 26 as the inserted hardware. There may alternatively be three or more of these fastener hardware pieces and corresponding grooves to secure the wear block to the foundation base. In FIG. 6, relatively wider holes 38 are drilled part of the way into the face of the wear block 34 with smaller holes 36 drilled entirely through the wear block. In this example, screws are screwed into the holes 36 and 38 and into the foundation base 32 to secure the block 34 to the base 32. The shoulder inside the larger holes 38 allows the heads of the screws to bear the block 34 onto the base 32.

FIGS. 7-10 illustrate alternative geometries that are possible with respect to the contact faces of the foundation base and the wear block. In FIG. 7, there is shown a bearing 40 with a foundation base 42 and wear block 44. The contact surface 46 has a smooth wave curved contact surface geometry. In FIG. 8, a bearing 50 has a foundation base 52 and wear block 54. There is shown a rectangular cutout contact surface 56 that is reciprocal between the respective foundation base 52 and wear block 54. FIGS. 9 and 10 illustrate bearings 60 and 70 with foundation blocks 62 and 72 and wear blocks 64 and 74 that have contact surfaces 66 and 76 that are reciprocal zig-zag geometries with FIG. 9 showing a larger and deeper pattern, while FIG. 10 illustrates a more fine ridged pattern. The regular straight-cut geometry of FIGS. 5 and 6 for instance is expected to be most common, because a straight cut is easier to make than a cut having significant three-dimensional geometry as shown in the FIGS. 7-10.

FIGS. 11 and 12 illustrate examples of bearings 80 and 90 that have a foundation base 82 and 92 and wear block 84 and 94 and contact surfaces 86 and 96 of different depths d1 and d2 respectively that might be used to trim off the worn face and define the size of the replacement wear block. As described earlier herein, the amount trimmed d1 in FIG. 11 may be relatively thin versus the overall depth of the original bearing. In FIG. 12, the depth d2 is relatively more substantial. This may be a function of many factors including the condition of the original bearing material and the amount of wear shown on the original bearing face.

FIG. 13 shows a bearing 100 with a foundation base 102 and wear block 104 and a contact surface 106. FIG. 13 is a demonstration of the example where the original bearing material m1 of the foundation base 102 that is trimmed off the face of that bearing may be different from the material m2 of the new wear block 104 that is attached to the foundation base. In one example, a metal or polymer foundation base 102 may have a lignum vitae wood wear block 104 fixed to it. In this way, all of the benefits of a lignum vitae bearing may be obtained without the need of installing a large block of lignum vitae wood. Only the wear block material is needed.

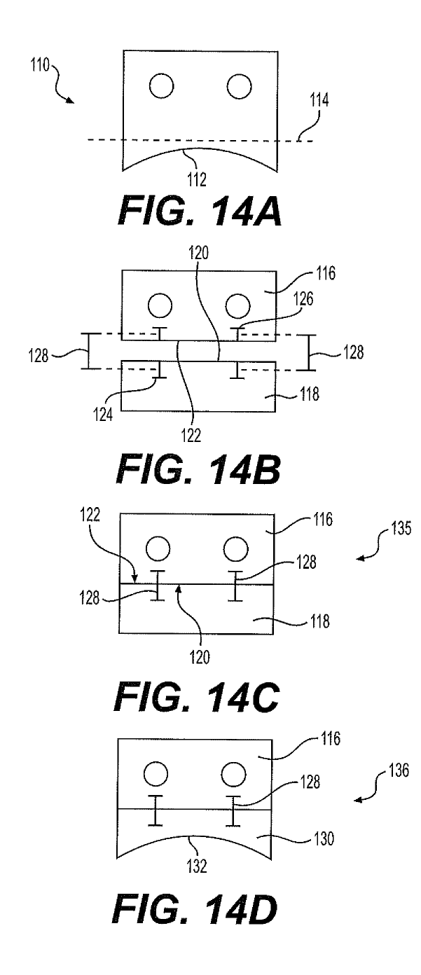

FIGS. 14A-D illustrate the series of steps that may be used to install a replacement wear block onto a worn bearing. As shown in FIG. 14A, step one of the process is to trim off the worn contact face 112 of the bearing 110 along a cut line 114. As shown in FIG. 14A, this cut line 114 is a straight cut down the length of the bearing at a constant depth and across the entire width of the bearing. As shown in FIG. 14B, the result of this trimming is a foundation base portion 116 of the old bearing and the waste material of the worn wear block having the worn contact face. In step 2 in FIG. 14B, a rough, un-milled wear block piece 118 is formed (in this example having a rectangular shape) to have a true reciprocal back side 120 that corresponds to the contact face 122 of the trimmed foundation base 116. As shown in FIG. 14B, “T” grooves 124 and 126 are milled into the respective faces of the foundation base contact face 122 and the wear block back side 120. These “T” shape grooves 124 and 126 in each face are carefully milled to be exactly opposite the similar groove in the opposing contact face. When the contact surfaces 120 and 122 of the foundation base 116 and the replacement wear block 118 are placed together, the respective “T” shapes form a single “I” shape groove. In FIG. 14C, rigid I-beam shape wedges 128 are formed that correspond in shape and dimension to the I-shaped grooves 124 and 126 in the bearing components. The I-beam wedges 128 are expected to be metal conducive to contact with a steel shaft without damaging that shaft, for instance bronze or aluminum, but the I-beam pieces can be formed of any durable and rigid material that will not score or damage. The I-beam wedges 128 act to resist shear forces from the shaft rotation as well as act as a clamping device. The contact face 122 of the foundation base 116 and the wear block back side 120 have adhesive coated onto them, in one example an epoxy, and then the two pieces are joined together by driving the I-beam clamp wedge 128 into both ends of the length of the combined bearing. Finally, as shown in FIG. 14D, once the combined beam 135 is secure, then the bearing contact face 132 of the wear block 130 is milled to the proper radius to align against a rotating shaft. The renovated bearing 136 is now ready for reinstallation in place around the rotating shaft.

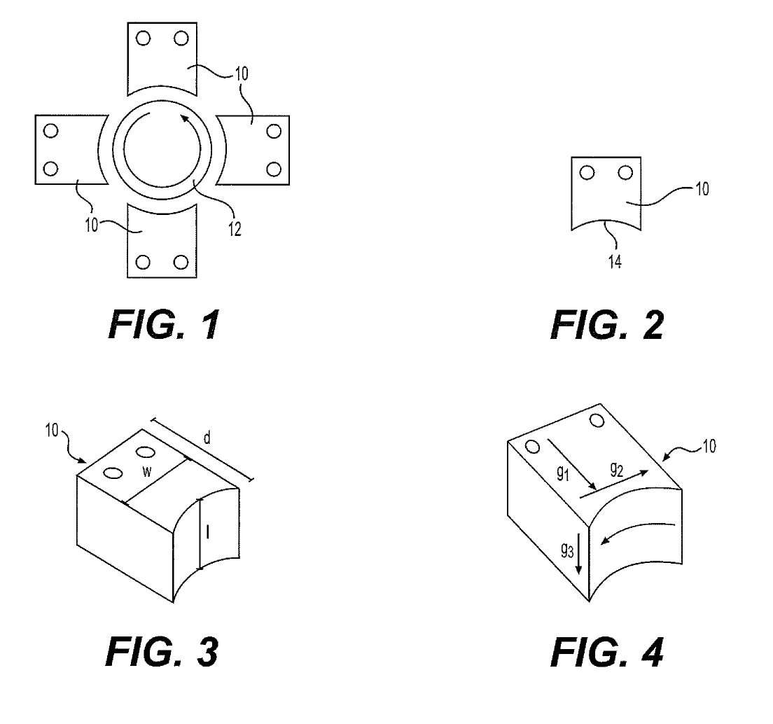

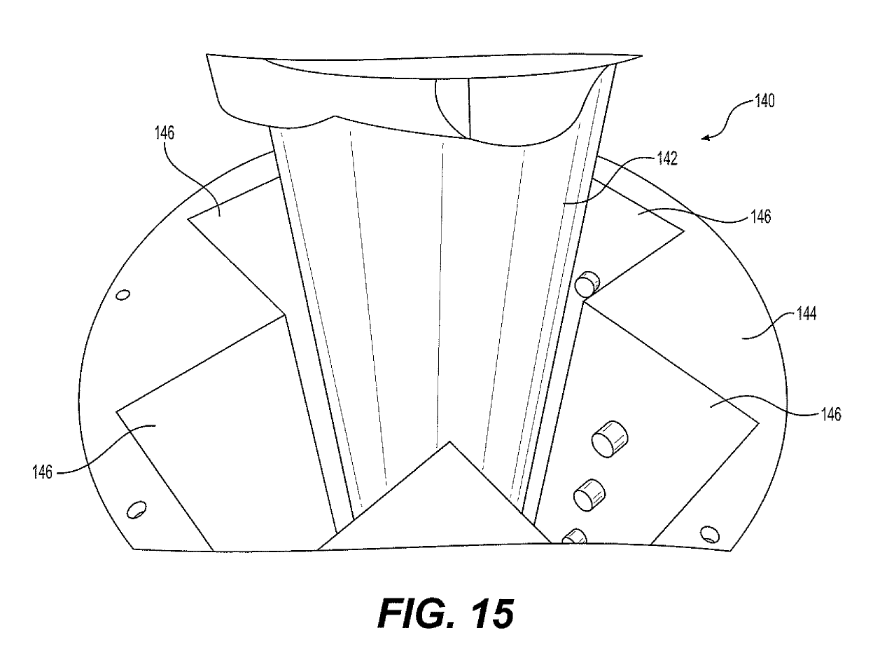

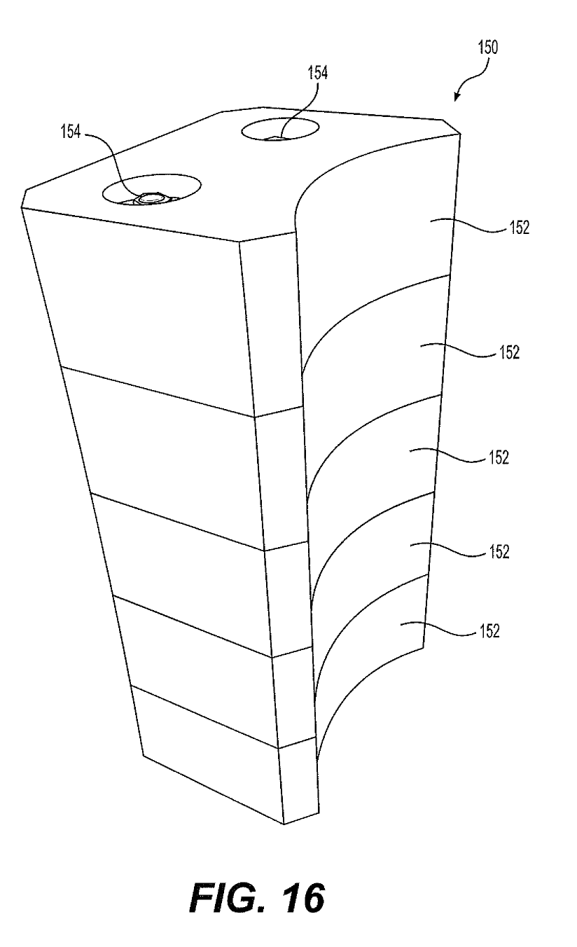

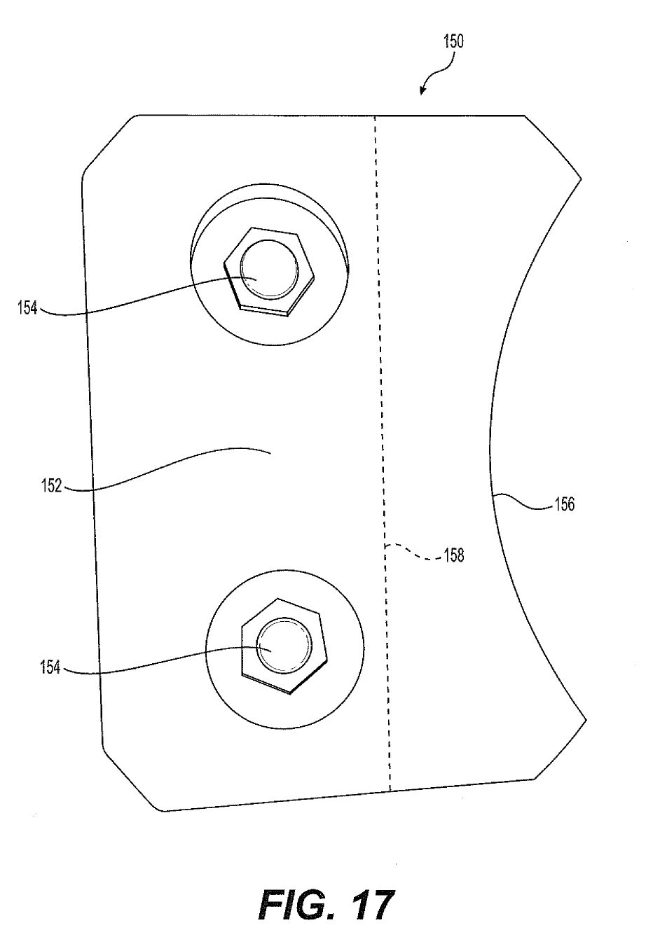

FIGS. 15-21 are additional views of an actual example of an installation of a renovated lignum vitae bearing around a shaft. FIG. 15 is a perspective view of a shaft and bearing system 140 with the actual bearings removed for maintenance. There is shown a large shaft 142 inside a bearing housing 144 where the four bearings have been removed, and the bearing slots 146 are seen. FIG. 15 correlates roughly, functionally to FIG. 1 showing a rotating shaft inside four bearings. FIG. 1 does not show a bearing housing like shown in FIG. 15. FIG. 16 is a perspective view of a worn bearing 150 as removed for example from a bearing slot 146 as shown in FIG. 15. The bearing 150 is formed of five blocks 152 stacked on each other and secured together by bolts 154. Similarly, FIG. 17 is a top view of the worn bearing 150. FIG. 17 is conceptually similar to FIG. 2. There is seen the bolts 154 and the worn wear face 156 of the top block 152. There is also shown broken line 158 which is the cut to be made to remove the front portion of the block 152 including the worn face 156.

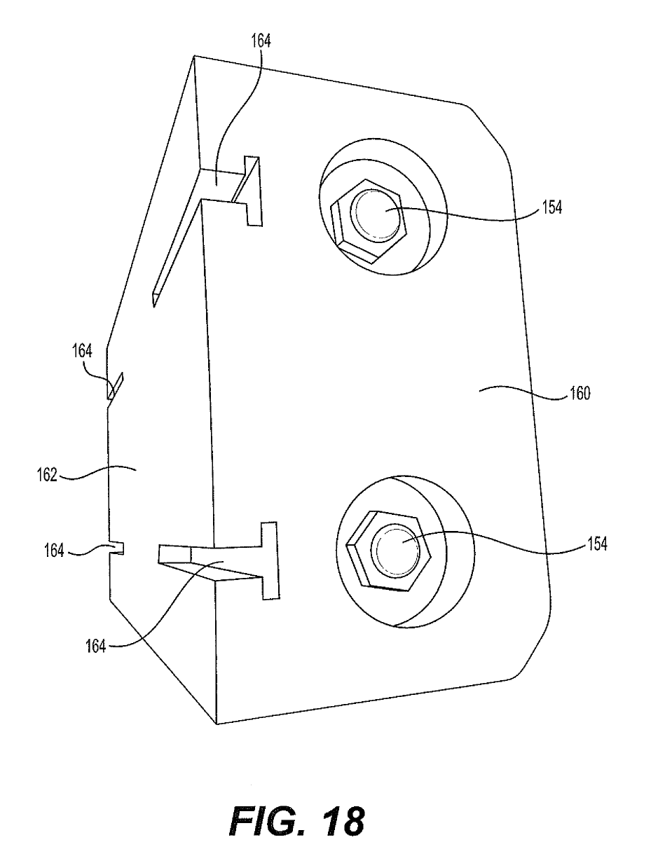

FIG. 18 is a top perspective view of the trimmed bearing that now forms a foundation base 160. The flat contact side 162 of the foundation base 160 has T-shape grooves 164 milled into the top and bottom portions of the foundation base. The new contact side 162 will be the contact face with a new wear block that will be secured to it. The length of these grooves 164 along the length of the foundation base 160 and the consequent length of the I-beam hardware that is driven into them is about 6-12 inches. A groove like groove 164 could be more or less in length depending on the size of the bearing to be renovated.

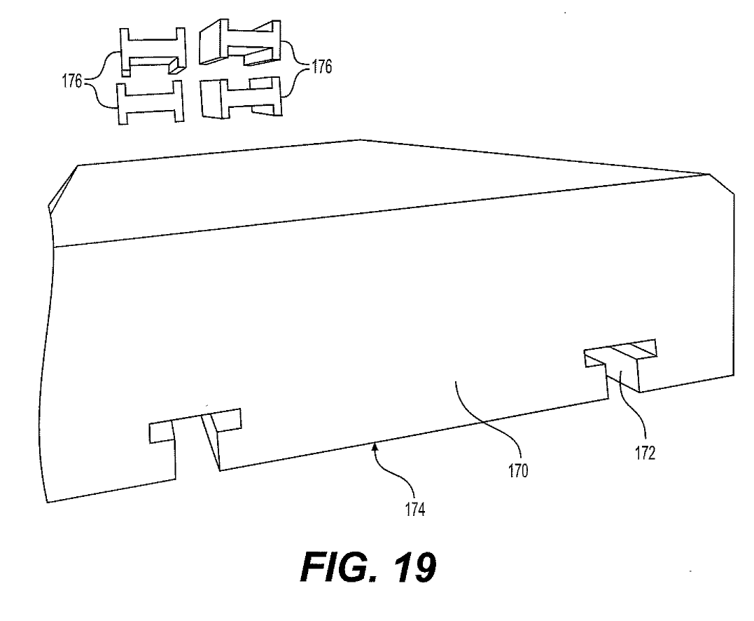

FIG. 19 shows a replacement wear block 170. As is readily apparent, this replacement wear block 170 is significantly smaller and comprises less material than an entire bearing. The replacement wear block 170 has “T” shaped grooves 172 milled into its back side 174 that will be the contact portion to a foundation base. These grooves 172 will align to the similar grooves milled into the trimmed face of the foundation base portion of the worn bearing. Also shown are the metal I-beam pieces 176 that will be driven into the I-beam shaped groove formed by the combined foundation base and wear block.

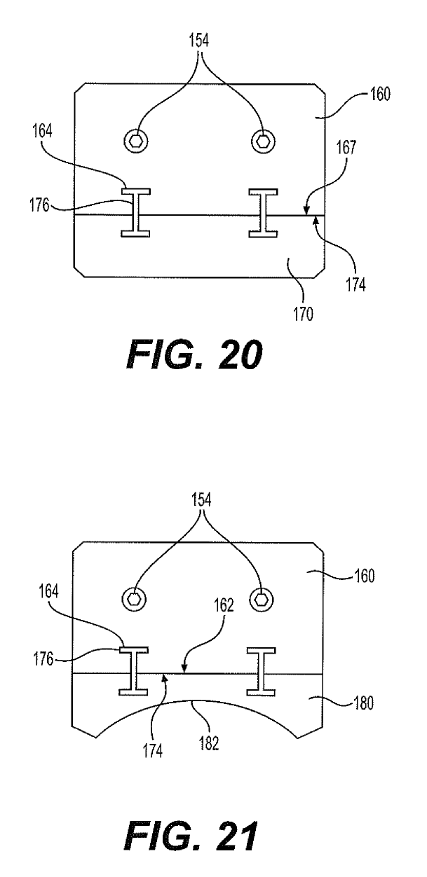

FIG. 20 shows the combined foundation base 160 and new wear block 170 as secured together by the I-beam wedges 176 that secure together the contact face 162 and back side 174. This rough wear block 170 is subsequently milled to form the new wear block 180 as shown in FIG. 21. The wear face 182 is milled to conform to the shape of a rotating shaft to be secured in place by the bearing.

Other embodiments of the present invention will be apparent to those skilled in the art from consideration of the specification. It is intended that the specification and Figures be considered as exemplary only, with a true scope and spirit of the invention being indicated by the following claims.

That which is claimed is:

1. A renovated shaft bearing comprising:
a foundation base and a replacement wear block;
wherein the foundation base is adapted to fit securely in a bearing housing, and the foundation base includes a contact side that is adapted to be oriented to face a rotating shaft;
wherein the replacement wear block has a back side and on its opposite side to the back side a wear face, and the back side is fixed to the contact side of the foundation base and the wear face is shaped to engage an outside diameter of the rotating shaft.

2. A renovated shaft bearing as described in claim 1,
wherein the contact side of the foundation base and the back side of the replacement wear block are each substantially flat.

3. A renovated shaft bearing as described in claim 1,
wherein the contact side of the foundation base and the back side of the replacement wear block each have a curved surface that is reciprocal to each other and that nest together.

4. A renovated shaft bearing as described in claim 1,
wherein the contact side of the foundation base and the back side of the replacement wear block each have a zig-zag surface that is reciprocal to each other and that nest together.

5. A renovated shaft bearing as described in claim 2,
wherein the respective flat faces each have reciprocal grooves therein, and the bearing further comprises wedges that are inserted into and hold the foundation base and replacement wear block together.

6. A renovated shaft bearing as described in claim 5,
wherein the wedges are dovetail wedges that hold the foundation base and replacement wear block together.

7. A renovated shaft bearing as described in claim 5,
wherein the wedges are I-beams that hold the foundation base and replacement wear block together.

8. A renovated shaft bearing as described in claim 1,
wherein the wear face has a hole therein, and the hole has a wide diameter section and a narrow diameter section,
wherein the wide diameter section extends across the wear face and part way through the cross section of the wear block to a bottom of the wide diameter section, and the narrow diameter section extends from the bottom of the wide diameter section and out through the back side of the replacement wear block;
and the bearing further comprises a fastener with a head and a body, wherein the head seats on the bottom of the wide diameter section of the hole and the body extends through the narrow section of the hole and is secured in the foundation base and secures the replacement wear block to the foundation base.

9. A renovated shaft bearing as described in claim 1,
wherein the foundation base and the replacement wear block are formed of different materials.

10. A renovated shaft bearing as described in claim 1,
wherein the foundation base and the replacement wear block are formed of lignum vitae wood.

11. A renovated shaft bearing as described in claim 1,
wherein the replacement wear block has a cross-sectional depth, as measured from the center of the width of the bearing, of from about one half to six inches.

12. A method of making a renovated shaft bearing comprising the steps of:
removing a shaft bearing from a bearing housing;
wherein the shaft bearing has a contact face that engages a rotating shaft;
cutting off the face of the shaft bearing to form a foundation base of the remaining portion of the shaft bearing, and the foundation base includes a contact side that is adapted to be facing the rotating shaft;
providing a replacement wear block that has a back side and a wear side, and wherein the back side of the replacement wear block has a surface that is adapted to be secured to the contact side of the foundation base;
securing the back side of the replacement wear block to the contact side of the foundation base; and
milling a radius of the rotating shaft into the wear side of the replacement wear block,
whereby the combination of the wear block face and the foundation base form a new shaft bearing.
